(19) United States
(12) Patent Application Publication
(10) Pub. No.: US 2026/0072491 A1
(43) Pub. Date: Mar. 12, 2026

(54) SYSTEMS AND METHODS FOR ADAPTIVE SOUND AND VOICE DETECTION

(71) Applicant: Ambiq Micro, Inc., Austin, TX (US)

(72) Inventors: Yousof MORTAZAVI, Austin, TX (US); Roger SERWY, Austin, TX (US); Mark MILLER, Austin, TX (US)

(21) Appl. No.: 18/827,035

(22) Filed: Sep. 6, 2024

(51) Int. Cl. G06F 1/3215; G10L 15/22; G10L 25/84

(52) U.S. Cl. CPC G06F 1/3215; G10L 15/22; G10L 25/84; G10L 2015/223

(57) ABSTRACT

In some embodiments, a system for detecting voice-based commands originating from a user includes a processor, as well as a memory module and an analog microphone which are both communicatively coupled to the processor. A comparator is further communicatively coupled to the analog microphone. Moreover, the comparator is configured to receive ambient audio samples collected by the analog microphone, and determine if any of the ambient audio samples are outside a first predetermined range. In response to determining that one or more of the ambient audio samples are outside the first predetermined range, the processor enters an active state from a deep-sleep state. However, the processor is maintained in the deep-sleep state in response to determining that none of the ambient audio samples are outside the first predetermined range. Other systems, methods, and computer program products are described in additional embodiments.

### TECHNICAL FIELD

The present disclosure relates generally to audio sampling. More particularly, aspects of this disclosure relate to low power audio detection implementations.

### BACKGROUND

In recent years, due to the growth of portable electronics, there has been a push to decrease the power used by processing systems (e.g., microcontrollers (“MCUs”), microprocessors, application processors, digital signal processors (“DSPs”), neural processing units (“NPUs”)) and other circuits used in portable electronic appliances. With lower power requirements, effective electronics operation time can be extended, or alternatively, smaller batteries can be used. Commonly, the power consumption of a microcontroller and associated circuits may be reduced by using a lower supply voltage, or by reducing the amount of internal capacitance being charged and discharged during the operation of the circuit.

One method for reducing microcontroller power relies on hardware or software-based power mode switching. Power modes can be selected for microcontroller components or resources based on operating state, operating conditions, and/or sleep cycle characteristics and other factors to configure low power modes for selected microcontroller components at the time the processor enters a low power or sleep state. In some systems, a set of predefined low power configurations can be used, while more sophisticated systems can dynamically select low power configurations to maximize power savings while still meeting system latency requirements.

However, even with available low power modes, microcontroller power usage can be adversely affected by interactions with connected sensors, memory systems, or other peripherals. Frequent interrupts or requests for service from such peripherals can greatly limit the time a microcontroller can remain in a low power mode. Systems that provide a reliable overall power management protocol and components for very low power operation are still needed.

### BRIEF DESCRIPTION OF THE DRAWINGS

The disclosure will be better understood from the following description of exemplary embodiments together with reference to the accompanying drawings, in which:

FIG. 1A is a block diagram illustrating an example of a low-power microcontroller system, according to aspects of the present disclosure.

FIG. 1B shows a continuation of the block diagram of FIG. 1A.

FIG. 1C shows a continuation of the block diagram of FIG. 1B.

FIG. 2 is a block diagram of an exemplary analog module that supplies power, external signals, and clock signals to the microcontroller system in FIGS. 1A-1C, according to some embodiments.

FIG. 3A is a partial representational view of a system for detecting voice-based commands originating from a user, according to some embodiments.

FIG. 3B is a partial representational view of a system for detecting voice-based commands originating from a user, according to some embodiments.

FIG. 3C is a partial representational view of a system for detecting voice-based commands originating from a user, according to some embodiments.

FIG. 3D is a partial representational view of a system for detecting voice-based commands originating from a user, according to some embodiments.

FIG. 4 is a flowchart showing exemplary operations for detecting voice-based commands originating from a user, according to some embodiments.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter; nor is it intended to be used in isolation to determine the scope of the claimed subject matter. The subject matter should be understood by reference to appropriate portions of the entire specification of this disclosure, any or all drawings and each claim.

One disclosed example is a system for detecting voice-based commands originating from a user. The system includes a processor, as well as a memory module and an analog microphone, which are both communicatively coupled to the processor. A comparator is further communicatively coupled to the analog microphone. Moreover, the comparator is configured to receive ambient audio samples collected by the analog microphone, and determine if any of the ambient audio samples are outside a first predetermined range. In response to determining that one or more of the ambient audio samples are outside the first predetermined range, the processor enters an active state from a deep-sleep state. However, the processor is maintained in the deep-sleep state in response to determining that none of the ambient audio samples are outside the first predetermined range.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3 - 5% of,” or “within acceptable manufacturing tolerances,” or any logical combination thereof, for example.

As previously discussed, there has been a push to decrease the power used by processing systems (e.g., microcontrollers (“MCUs”), microprocessors, application processors, digital signal processors (“DSPs”), neural processing units (“NPUs”), graphics processing units (“GPUs”)) and other circuits used in portable electronic devices. For ease of discussion, such processing systems will generally be referred to as “processing systems” or more generally as “processors” herein, though it should be appreciated that the disclosure provided herein can be applied to any suitable processing systems. One method for reducing power consumption relies on hardware and/or software based power mode switching. For example, when the device is in a deep-sleep state or a functional sleep state (i.e., a low power mode), one or more components of the system are turned off or provided with a lower power level. While this can reduce the power consumption of the device, even in a sleep state, the device is still provided with some power.

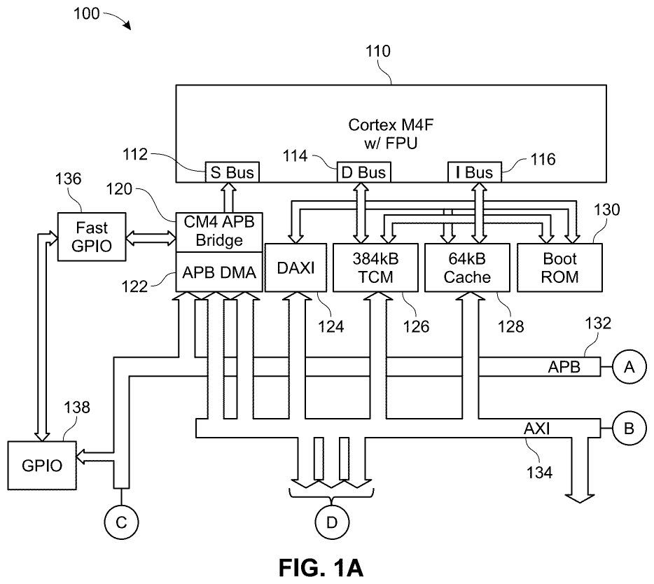

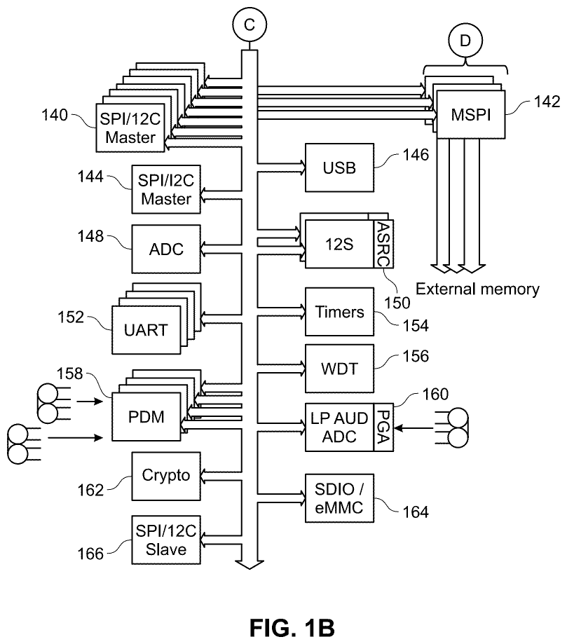

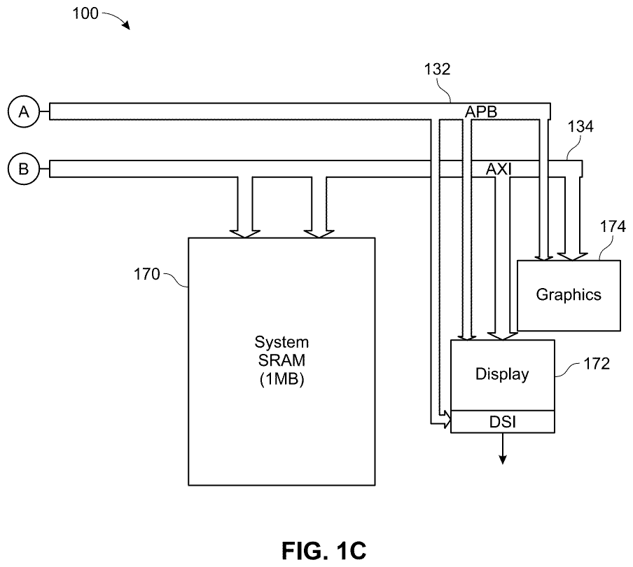

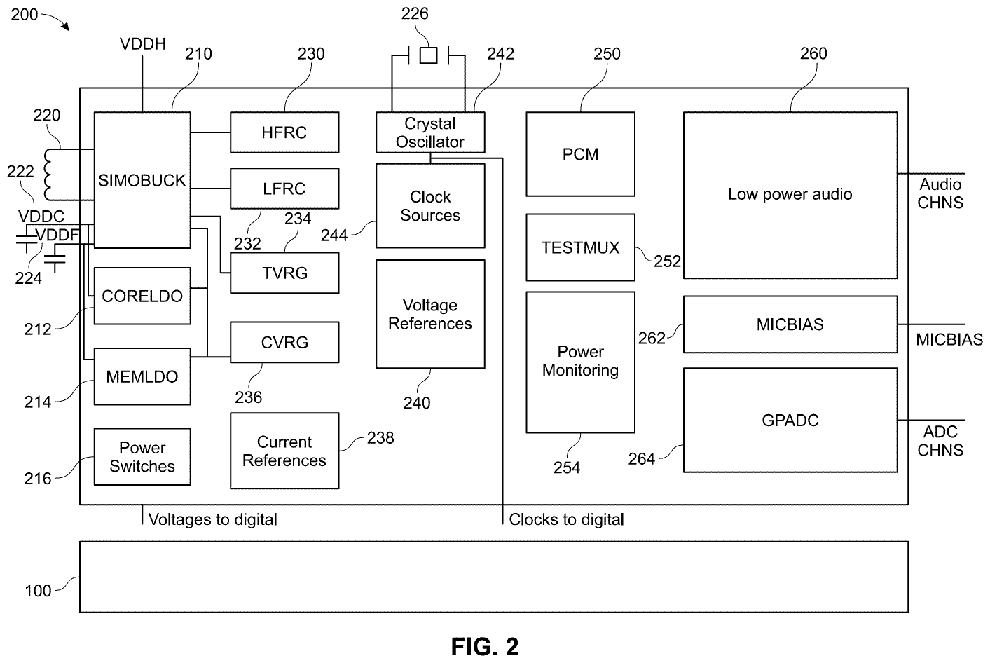

Described herein are systems, methods, and apparatuses that seek to reduce the power consumption of a system by maintaining processors in deep-sleep states until it is advantageous to return them to an active state. For example, one system is for detecting voice-based commands originating from a user. The system includes a processor, a memory module, and an analog microphone. A comparator is further electrically connected to the analog microphone. Moreover, the comparator is configured to receive ambient audio samples collected by the analog microphone, and determine if any of the ambient audio samples are outside a first predetermined range. In response to determining that one or more of the ambient audio samples are outside the first predetermined range, the processor enters an active state from a deep-sleep state. However, the processor is maintained in the deep-sleep state in response to determining that none of the ambient audio samples are outside the first predetermined range. The discussion of FIGS. 1A-2 provide an overview of an MCU system that can be used with the voice-based command detection implementations described herein.

FIG. 1A-1C depict a block diagram of an example low power microcontroller system 100 of an overall MCU. The example low power microcontroller system 100 includes a central processing unit (CPU) 110. The CPU 110 in this example is Cortex M4F (CM4) with a floating point unit. The CPU 110 includes a System-bus interface 112, a Data-bus interface 114, and an Instruction-bus interface 116. It is to be understood, that other types of general CPUs, or other processors such as DSPs or NPUs may incorporate the principles described herein.

The System-bus interface 112 is coupled to a Cortex CM4 advanced peripheral bus (APB) bridge 120 that is coupled to an advanced peripheral bus (APB) direct memory access (DMA) module 122. The microcontroller system 100 includes a Data Advanced eXtensible Interface (DAXI) 124, a tightly coupled memory (TCM) 126, a cache 128, and a boot ROM 130. The Data-bus interface 114 allows access to the DAXI 124, the TCM 126, the cache 128, and the boot read only memory (ROM) 130. The Instruction-bus interface 116 allows access to the TCM 126, the cache 128, and the boot ROM 130. In this example, the DAXI interface 124 provides write buffering and caching functionality for the microcontroller system 100. The DAXI interface 124 improves performance when accessing peripherals like the SRAM and the MSPIs.

An APB (Advanced Peripheral Bus) 132 and an Advanced eXtensible Interface (AXI) bus 134 are provided for communication between components on the microcontroller system 100. The APB 132 is a low speed and low overhead interface that is used for communicating with peripherals and registers that don't require high performance and don't change often (e.g., when a controller wants to set configuration bits for a serial interface). The AXI bus 134 is an ARM standard bus protocol that allows high speed communications between multiple masters and multiple busses. This is useful for peripherals that exchange large amounts of data (e.g., a controller that talks to an analog to digital converter (ADC) and needs to transfer ADC readings to a microcontroller or a GPU that talks to a memory and needs to transfer a large amount of graphics data to/from memories).

A fast general purpose input/output (GPIO) module 136 is coupled to the APB bridge 120. A GPIO module 138 is coupled to the fast GPIO module 136. The APB bus 132 is coupled to the GPIO module 138. The APB bus 132 is coupled to a series of Serial Peripheral Interface/Inter-Integrated Circuit (SPI/I2C) interfaces 140 and a series of Multi-bit Serial Peripheral Interfaces (MSPI)s 142. The MSPIs 142 are also coupled to the AXI bus 134 and provide access to external memory devices.

The APB bus 132 also is coupled to a SPI/I2C interface 144, a universal serial bus (USB) interface 146, an ADC 148, an Integrated Inter-IC Sound Bus (I2S) interface 150, a set of Universal Asynchronous Receiver/Transmitters (UART)s 152, a timers module 154, a watch dog timer circuit 156, a series of pulse density modulation (PDM) interfaces 158, a low power audio ADC 160, a cryptography module 162, a Secure Digital Input Output/Embedded Multi-Media Card (SDIO/eMMC) interface 164, and a SPI/I2C slave interface module 166. The PDM interfaces 158 may be connected to external digital microphones. The low power audio ADC 160 may be connected to an external analog microphone through internal programmable gain amplifiers (PGA).

A system static random access memory (SRAM) 170, which is 1 MB in this example, is accessible through the AXI bus 134. The microcontroller system 100 includes a display interface 172 and a graphics interface 174 that are coupled to the APB bus 132 and the AXI bus 134.

Components of the disclosed microcontroller system 100 are further described by U.S. Provisional Ser. No. 62/557,534, titled “Very Low Power Microcontroller System,” filed Sep. 12, 2017; U.S. application Ser. No. 15/933,153, filed Mar. 22, 2018 titled “Very Low Power Microcontroller System,” (Now U.S. Pat. No. 10,754,414), U.S. Provisional Ser. No. 62/066,218, titled “Method and Apparatus for Use in Low Power Integrated Circuit,” filed Oct. 20, 2014; U.S. application Ser. No. 14/855,195, titled “Peripheral Clock Management,” (Now U.S. Pat. No. 9,703,313), filed Sep. 15, 2015; U.S. application Ser. No. 15/516,883, titled “Adaptive Voltage Converter,” (Now U.S. Pat. No. 10,338,632), filed Sep. 15, 2015; U.S. application Ser. No. 14/918,406, titled “Low Power Asynchronous Counters in a Synchronous System,” (Now U.S. Pat. No. 9,772,648), filed Oct. 20, 2015; U.S. application Ser. No. 14/918,397, titled “Low Power Autonomous Peripheral Management,” (Now U.S. Pat. No. 9,880,583), filed Oct. 20, 2015; U.S. application Ser. No. 14/879,863, titled “Low Power Automatic Calibration Method for High Frequency Oscillators,” (Now U.S. Pat. No. 9,939,839), filed Oct. 9, 2015; U.S. application Ser. No. 14/918,437, titled “Method and Apparatus for Monitoring Energy Consumption,” (Now U.S. Pat. No. 10,578,656), filed Oct. 20, 2015; U.S. application Ser. No. 17/081,378, titled “Improved Voice Activity Detection Using Zero Crossing Detection,” filed Oct. 27, 2020, U.S. application Ser. No. 17/081,640, titled “Low Complexity Voice Activity Detection Algorithm,” filed Oct. 27, 2020, all of which are hereby incorporated by reference.

While the discussion of FIG. 1A-1C describes a microcontroller system 100, the discussion of FIG. 2 describes an analog module 200 that supplies power, external signals, and clock signals to the microcontroller system 100. In one embodiment, both the digital module (i.e., the microcontroller system 100 of FIG. 1A-1C) and the analog module 200 of FIG. 2 are on board an MCU that is fabricated on a chip.

FIG. 2 depicts a block diagram of an analog module 200 that interfaces external components with the microcontroller system 100 in FIG. 1A - 1C. The analog module 200 supplies power to different components of the microprocessor system 100 as well as providing clocking signals to the microcontroller system 100. The analog module 200 includes a Single Inductor Multiple Output (SIMO) buck converter 210, a core low drop-out (LDO) voltage regulator 212, and a memory LDO voltage regulator 214. The LDO voltage regulator 212 supplies power to processor cores of the microcontroller system 100, while the memory LDO voltage regulator 214 supplies power to volatile memory devices of the microcontroller system 100 such as the SRAM 170. A switch module 216 represents switches that allow connection of power to the different components of the microcontroller system 100.

The SIMO buck converter module 210 is coupled to an external inductor 220.

The module 200 is coupled to a VDDC capacitor 222 and a voltage dipolar direct flash (VDDF) capacitor 224. In some embodiments, the VDDC capacitor 222 and the VDDF capacitor 224 provide respective different voltages (VDDC and VDDF) to the system from the analog module 200. The module 200 is also coupled to an external crystal 226.

The SIMO buck converter 210 is coupled to a high frequency resistor-capacitor (HFRC) oscillator 230, a low frequency resistor-capacitor (LFRC) oscillator 232, and a temperature coefficient voltage reference generator (TVRG) circuit 234. The HFRC 230 and the LFRC 232 are clock supplies that can be used, for example, to trigger a comparator to determine if the SIMO buck converter 210 needs to replenish a rail. A calibrated voltage reference generator (CVRG) circuit 236 is coupled to the SIMO buck converter 210, the core LDO voltage regulator 212, and the memory LDO voltage regulator 214. Thus, temperature compensation is performed on the voltage sources. A set of current reference circuits 238 is provided as well as a set of voltage reference circuits 240.

In this example, the LDO voltage regulators 212 and 214 are used to power up the microcontroller system 100. The more efficient SIMO buck converter 210 is used to power different components on demand.

A crystal oscillator circuit 242 is coupled to the external crystal 226. The crystal oscillator circuit 242 provides a drive signal to a set of clock sources 244. The clock sources 244 include multiple clocks providing different frequency signals to the components on the microcontroller system 100.

The analog module 200 also includes a process control monitoring (PCM) module 250 and a test multiplexer 252. Both the PCM module 250 and the test multiplexer 252 allow testing and trimming of the microcontroller system 100 prior to shipment. The PCM module 250 includes test structure that allow programming of the compensation voltage regulator 236. The test multiplexer 252 allows trimming of different components on the microcontroller system 100. The analog module 200 includes a power monitoring module 254 that allows power levels to different components on the microcontroller system 100 to be monitored. The power monitoring module 254 in this example includes multiple state machines that determine when power is required by different components of the microprocessor system 100. The power monitoring module 254 works in conjunction with the power switch module 216 to supply appropriate power when needed to the components of the microprocessor system 100. The analog module 200 includes a low power audio module 260 for audio channels, a microphone bias module 262 for biasing external microphones, and a general purpose analog to digital converter 264.

The SIMO buck converter 210 (shown in FIG. 2) supplies DC voltage at different levels to components and devices of the microcontroller system 100 in FIG. 1 and the analog module 200 in FIG. 2. As explained above, the SIMO buck converter 210 is coupled via the power switch module 216 to provide power and thus enable different components and devices on the microcontroller system 100 and the analog module 200. The SIMO buck converter 210 serves as an efficient power supply for the components and devices on the microcontroller system 100 and the analog module 200.

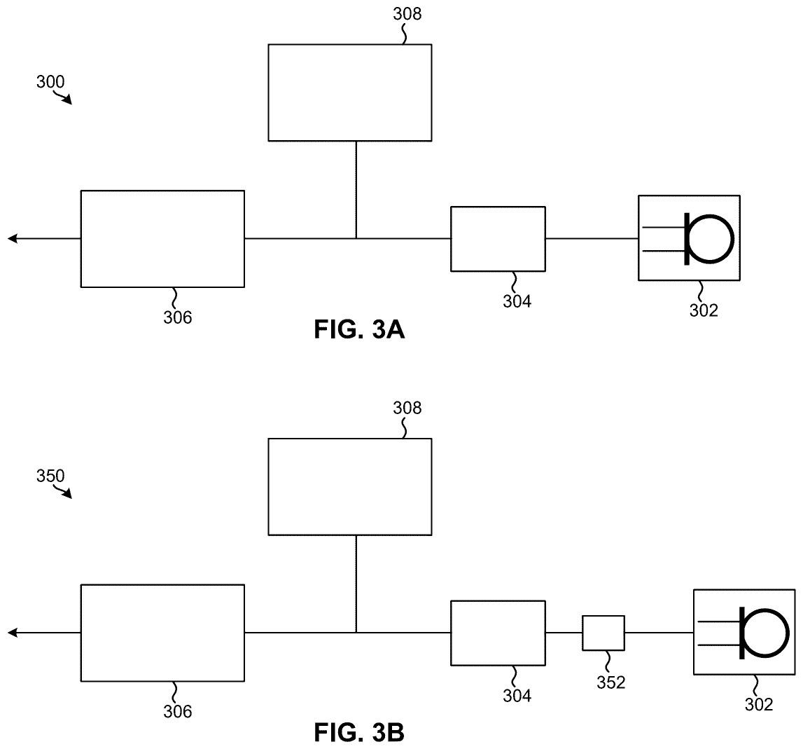

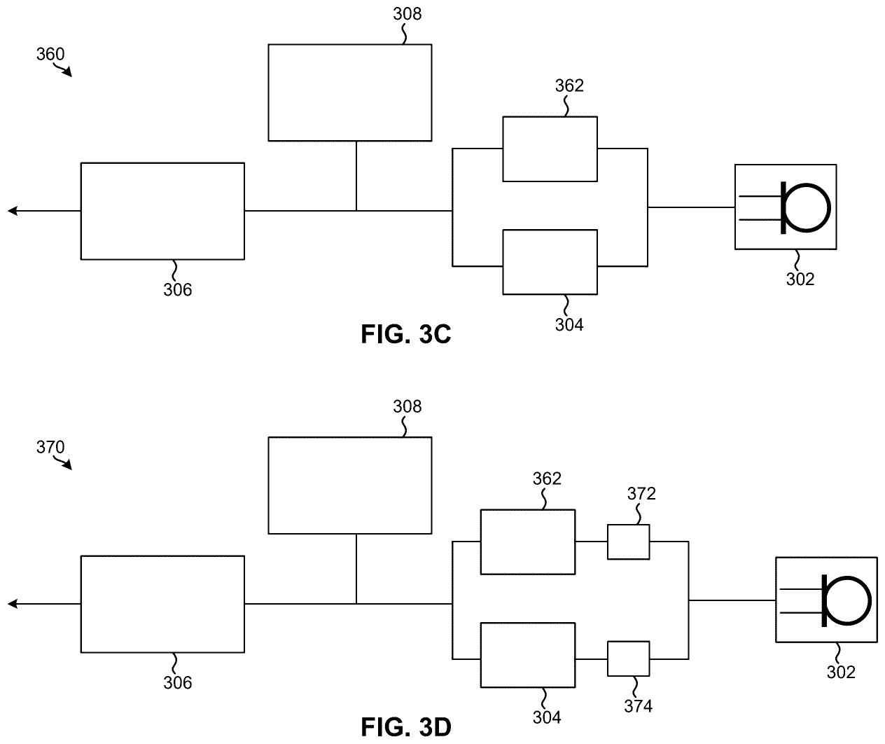

While the discussion of FIG. 1A-1C, and FIG. 2 provides detail regarding a microcontroller system and an analog module, the discussion of FIG. 3-5 describes a power source configured to supply power to the microcontroller system and/or analog module.

As previously mentioned, conventional audio processing implementations have been plagued by inefficiencies. For instance, conventional systems have resorted to processing all detected audio signals, which is a significant draw on available resources such as compute throughput and power. Some conventional systems have implemented digital components in an attempt to overcome these inefficiencies, but any resulting power savings are negated by the high inefficiencies of these digital components. In other words, the digital components consume a greater amount of power than they are able to conserve.

In sharp contrast, various ones of the embodiments included herein are desirably able to selectively transition processing components between a deep-sleep (e.g., reduced power and/or functionality) state and an active state. This allows for overarching systems to conserve a significant amount of power, compute overhead, system throughput, etc. Moreover, by increasing the amount of time the processing components are in a deep-sleep state, these improvements are amplified. Thus, by only processing audio samples that are identified as being of interest, embodiments described herein are able to achieve significant advancements over what has been conventionally achievable, e.g., as will be described in further detail below.

Looking now to FIG. 3A, a detailed representational view of a system 300 for detecting voice-based commands originating from a user is illustrated in accordance with one embodiment. As an option, the present system 300 may be implemented in conjunction with features from any other embodiment listed herein, such as those described with reference to the other FIGS., such as FIGS. 1-2. For example, one or more of the components included in system 300 may be coupled to the low power audio ADC 160 of FIG. 1A. However, such system 300 and others presented herein may be used in various applications and/or in permutations which may or may not be specifically described in the illustrative embodiments listed herein. Further, the system 300 presented herein may be used in any desired environment. Thus FIG. 3A (and the other FIGS.) may be deemed to include any possible permutation.

As shown, the system 300 includes an analog microphone 302 that is electrically connected (e.g., coupled) to a comparator 304. The analog microphone 302 may be of any desired type depending on the implementation, but is preferably configured to detect audio signals that exist in the surrounding environment and collect analog audio data that corresponds thereto. Accordingly, the analog microphone 302 is able to detect various types of audio signals and record analog data therefrom, e.g., such as amplitudes, frequencies, etc. of the audio signals.

This analog data (e.g., “ambient audio samples”) collected by the analog microphone 302 are provided to the comparator 304. The comparator 304 is preferably able to distinguish between different types of the audio signals received from the analog microphone 302. Moreover, by comparing the different audio signals to a standard of some kind, the comparator 304 can identify certain audio signals that meet specific criteria. For example, audio signals having a frequency and/or amplitude in a predetermined range may be identified by the comparator 304 as being of interest, e.g., as described in further detail below.

The comparator 304 is also able to selectively pass these identified audio samples downstream to the processor 306 and/or memory 308, which are electrically coupled thereto. It follows that the processor 306, memory module 308, comparator 304, and analog microphone 302 are preferably communicatively coupled to each other, e.g., such that data, commands, requests, logical values, etc., may be sent between each of the components as desired. The comparator 304 may thereby act as a valve that selectively allows certain audio signals captured by the analog microphone 302 to pass to a remainder of the system 300. This allows the processor 306 to remain in a deep-sleep state until an audio sample of interest has been received, indicating that it is advantageous for the processor 306 to return to an active state. Once in the active state, the processor 306 is able to evaluate the audio sample of interest, and determine further information associated therewith. Depending on the approach, the processor 306 may include microcontroller, a microprocessor, an embedded processor, digital signal processor, media processor, neural processing unit (NPU), etc., or any other desired type of processing circuit(s), chip(s), and/or module(s) implemented in hardware and/or software.

Moreover, the memory module 308 may include any desired type of memory. For instance, in some implementations the memory module 308 may include a type of memory having a plurality of memory blocks, such as RAM (e.g., SRAM, DRAM, Synchronous Dynamic RAM (SDRAM). etc.), Flash, etc. In other implementations, the memory module 308 may include other types of volatile and/or non-volatile memory. It follows that in some approaches, the memory module 308 may be (or include) a cache which accumulates audio samples. This accumulation of audio samples may be received from the comparator 304 as the audio data is collected by the microphone 302, while in other instances an ADC may periodically convert audio samples from the microphone 302 and store them in the cache (e.g., buffer) for bulk evaluation once the processor 306 has been activated. This allows the processor 306 to remain in a deep-sleep state until a predetermined number of audio samples (e.g., an amount of data) have accumulated in the memory module 308, indicating that it is advantageous for the processor 306 to return to an active state to efficiently process the cached audio samples rather than waking periodically to process each sample as it is received.

With respect to the present description, a “deep-sleep state” is intended to refer to a type of low power state, during which the respective device is in a sleep state or a functional sleep state (i.e., a low power mode) where one or more electrical components of the device are turned off or provided with a lower power level. As a result, the power consumption of the device is significantly reduced compared to at least an active state. It should also be noted that the “active state” is intended to refer to a power state that is higher than the deep-sleep state, during which the respective device is provided sufficient power such that one or more processors in the device are in a functional (e.g., operational) state.

It follows that by selectively transitioning the processor 306 between this deep-sleep state and active state, the system 300 is able to conserve a significant amount of power, compute overhead, system throughput, etc. Moreover, by increasing the amount of time the processor 306 is in a deep-sleep state, these improvements are amplified. Thus, by only processing audio samples that are identified as being of interest, embodiments described herein are able to achieve significant advancements over what has been conventionally achievable. Performance may be further improved by clocking the processor at between 10 times and 100 times the sampling rate of the system. The processor may even operate at 100 kHz while processing audio samples in the kHz range, e.g., as would be appreciated by one skilled in the art after reading the present description.

For instance, while the analog microphone 302 can detect various audio signals, certain types of audio signals may provide more value than others. As previously mentioned, it is desirable to distinguish between different types of audio signals and identify ones that are of interest. This allows for compute resources to be conserved and dedicated to processing audio signals that are of interest, rather than all audio signals detected by the analog microphone 302. According to an example, which is in no way intended to limit the disclosure, while the analog microphone 302 is able to detect different types of audio signals, e.g., such as background noise in addition to voice commands, processing background noise will result in a waste of system resources, including power (e.g., battery power) and compute overhead. Thus, by evaluating the audio signals that are detected to identify audio signals of interest, various ones of the embodiments included herein are able to significantly improve operating efficiency of the system by reducing power use, decreasing processing overhead, increasing achievable throughput, etc.

The comparator 304 is thereby preferably configured to evaluate different audio signals and identify ones that are of particular interest. In other words, the comparator 304 is preferably able to differentiate background noise from more substantive audio signals, e.g., such as audio signals that correspond to the voice of a user. Again, by differentiating between different types of audio signals, the comparator 304 is desirably able to filter out noise that does not pertain to the system 300.

According to some approaches, the comparator 304 compares the ambient audio samples to a first predetermined range in order to filter out noise as mentioned above. For instance, one implementation includes the comparator 304 comparing a frequency of each of the ambient audio samples to a first predetermined frequency range to determine if any of the ambient audio samples are outside the first predetermined frequency range. Audio noise typically corresponds to combinations of higher and lower frequencies, while human voices (speech) primarily correspond to lower frequencies with a reduced number of transitions between higher and lower frequencies. The comparator 304 may thereby identify an ambient audio sample as being of interest if it is a lower frequency than frequencies in a predetermined range. The range may be predetermined by the user, based on industry standards, using testing performance metrics, etc. In some implementations, the frequency range may be adjusted dynamically over time as the system is tuned for the specific environment it is positioned in. It should also be noted that the term “lower than a range” is in no way intended to limit the invention. Rather than determining whether a value below a range, equivalent determinations may be made, e.g., as to whether an absolute value is above a threshold, whether a value is below a threshold, etc., depending on the desired approach.

With continued reference to FIG. 3A, the comparator 304 may thereby be configured to identify ambient audio samples that are of interest (e.g., have an average frequency that is below a predetermined range) and activate the processor 306 as a result. Again, these identified samples typically correspond to human voices (speech) and therefore are ideal candidates for further processing. For instance, audio samples identified as including at least one person's voice may include a voice-based command that the system is configured to process. However, the comparator 304 may be configured to identify different types of audio samples in any desired way. For instance, certain sequences of sounds (e.g., notes, frequencies, amplitudes, etc.) and/or specific words (e.g., “wake words”) may be used to identify specific audio samples that are of interest, and may thereby be used to selectively activate the processor 306. Thus, by identifying specific audio samples to perform further audio processing on, the system is able to maintain accurate performance, while also conserving significant system resources.

In response to identifying an audio sample that is of interest, the comparator 304 may cause the processor to enter an active state from a deep-sleep state differently, e.g. depending on the implementation. For instance, in some implementations the comparator 304 may send a logic value to the processor 306 along an interrupt line, wherein upon receiving the logic value, the processor 306 enters the active state from the deep-sleep state. In other implementations, the comparator 304 may cause a voltage supplied to the processor 306 to be increased such that the processor 306 is able to perform additional functions. In such implementations, one or more transistors may receive information (e.g., logic values) from the comparator and be used to physically regulate the flow of electrical current to the processor 306 and/or any other components.

Once in the active state, the processor 306 is able to determine if any of the ambient audio samples identified as being of interest actually correspond to a voice-based command originating from a user. In other words, the processor 306 causes the identified audio samples to be further evaluated, e.g., to determine additional details. According to some implementations, the audio samples of interest may be further evaluated by the processor 306 implementing a voice activity detection (VAD) computer program product. The VAD computer program product includes program instructions which, when executed by the processor 306, cause the processor 306 to evaluate the one or more ambient audio samples identified as being of interest, and verifying whether each of the audio samples of interest correspond to a voice-based command originating from a user. The specific sub-processes that are performed to determine whether the audio samples of interest correspond to a voice-based command may include distributional semantics, semantics-based deep-learning (e.g., supervised, semi-supervised, or unsupervised machine learning), voice recognition technology, etc. As noted above, memory module 308 may be used to store data that may be used in the process of evaluating audio samples identified as being of interest.

In other implementations, the audio samples of interest may be further evaluated by the processor 306 sending one or more instructions to a VAD module (not shown). The VAD module may implement VAD computer program products and/or other software that has been implemented in a hardware block, e.g., as would be appreciated by one skilled in the art after reading the present description. Accordingly, the VAD module may be able to perform any of the sub-processes described above as being able to determine if an audio sample corresponds to a voice-based command.

Audio samples that have been evaluated further by the processor 306 may be handled differently depending on the situation. For example, in some situations evaluated audio samples may be transferred to a different system, e.g., such as the low power microcontroller system 100 of FIG. 1A-1C. In other situations, certain data associated with the audio samples may be stored in the memory module 308. In still other situations, audio samples determined as not corresponding to a voice based command may be deleted.

Once the processor 306 has evaluated each of the ambient audio samples identified by the comparator 304 as being of value, the processor 306 may automatically return to a deep-sleep state. As noted above, this significantly reduces power consumption and improves efficiency of the system 300.

While it is beneficial to avoid activating the processor 306 unless evaluating audio samples of interest, the processor 306 may be activated at select times to ensure the system 300 is operating properly. For instance, in some implementations the comparator 304 is an adjustable voltage-based comparator that is calibrated for different uses. These adjustable comparators benefit from being recalibrated periodically over time to ensure they are operating effectively. Accordingly, in some approaches the processor 306 is configured to automatically return to the active state for a short period. The processor 306 may thereby return to the active state irrespective of performance of the comparator 304. For instance, the processor 306 may enter the active state in at predetermined time intervals (e.g., in response to an internal clock and/or program), after a specific number of audio samples have been received by the comparator, etc.

Once in the active state, the processor 306 may evaluate performance of various components of the system 300 to ensure they are operating efficiently. For instance, the processor 306 may determine an amount of time it has been since a last audio sample was identified as being of interest. In situations where it has been an unusually long time since a last audio sample was identified as being of interest, the processor 306 may automatically recalibrate the comparator 304. This ensures that the comparator 304 is accurately evaluating the audio samples received from the analog microphone 302 and avoiding situations where voice-based commands and/or “wake-words” are unintentionally being ignored. In some implementations, the processor 306 may even review each of the audio signals that are detected by the analog microphone 302.

In other approaches, processor 306 may enter the active state based on the amount of time that has passed since the processor 306 was last in the active state. For instance, the processor 306 may maintain a counter even in deep-sleep state that tracks how long it has been since the processor 306 last entered the active state. It follows that in response to the counter reaching a value, the processor 306 would automatically enter the active state. Once in the active state, the processor 306 may automatically recalibrate the comparator 304. Again, this ensures that the comparator 304 is accurately evaluating the audio samples received from the analog microphone 302 and avoiding situations where voice-based commands are unintentionally being ignored, e.g., as described above.

The process of recalibrating the comparator 304 may be performed in some implementations by implementing an ADC. For example, one or more instructions may be sent to the ADC, causing the ADC to process updated (e.g., new, or current) ambient audio samples received from the analog microphone. The ADC may be activated at a repeating interval to process updated ambient audio samples as they are received to determine if any changes have occurred.

The ADC may process the updated ambient audio samples by converting the analog data into the digital domain. These digital representations of the updated ambient audio samples may thereby be used to evaluate the performance and settings of the comparator 304. In some implementations, the digital representations may be used to evaluate the comparator 304 as they are created.

In other implementations the digital representations may be accumulated in a buffer (e.g., cache). For example, a buffer operating at 16 kHz may be implemented to store a backlog of ambient audio samples. This backlog may allow for the cache to provide a pre-roll of about 500 milliseconds, but could be higher or lower depending on the approach. It follows that the buffer allows for a predetermined number of digital representations to be stored therein before using the processor to perform an evaluation. Thus, the processor 306 may actually return to an active state in response to a predetermined number of digital representations being stored in the buffer. This minimizes the number of times that the processor is returned to an active state to successfully recalibrate the comparator 304.

Once the comparator 304 has been recalibrated, subsequently received ambient audio signals may be processed differently. For instance, the recalibration process updates predetermined ranges that are applied to ambient audio signals that are received. It follows that ambient audio signals are compared to one or more different predetermined ranges as a result of recalibrating the comparator 304 in preferred implementations. Thus, the system 300 is able to maintain efficient performance while also reducing electrical power consumption and compute overhead.

Looking now to FIG. 3B, a detailed representational view of a system 350 for detecting voice-based commands originating from a user is illustrated in accordance with one embodiment. Specifically, FIG. 3B illustrates a variation of the embodiment of FIG. 3A having an exemplary configuration for processing ambient audio samples. Accordingly, various components of FIG. 3B have common numbering with those of FIG. 3A. The present system 350 may also be implemented in conjunction with features from any other embodiment listed herein, such as those described with reference to the other FIGS., such as FIG. 1A-2.

As shown in FIG. 3B, the system 350 includes the processor 306, memory module 308, and comparator 304 electrically coupled to each other, e.g., as seen above in FIG. 3A. Additionally, system 350 includes a frequency-based filter 352 that is positioned between the comparator 304 and the analog microphone 302. The frequency-based filter 352 may thereby prevent certain ones of the ambient audio signals captured by the analog microphone 302 from being provided to the comparator 304.

The audio signals that are actually removed by the frequency-based filter 352 may differ depending on the implementation. For instance, in some situations the frequency-based filter 352 is a band-pass filter capable of passing audio signals having frequencies in a certain range along to the comparator 304, while rejecting (attenuating) audio signals having frequencies that are outside that range. According to an example, which is in no way intended to limit the invention, the frequency-based filter 352 may be a low-pass filter that passes audio signals with a frequency lower than a selected cutoff frequency, and attenuates audio signals with frequencies higher than the cutoff frequency. It follows that the specific frequency response of the frequency-based filter 352 depends on its design. Although the system 350 is illustrated as implementing a frequency-based filter 352, it should be noted that audio signals captured by the analog microphone 302 may be pre-processed differently in other implementations.

It follows that the system 350 is able to selectively ignore certain audio samples that are captured by the analog microphone. These audio samples that are ignored and removed before reaching the comparator 304 may correspond to situations that are known to not produce voice based commands. For instance, background noise in certain environments may have a distinguishable noise profile and may thereby be preemptively filtered out of the system 350 upon being detected.

FIG. 3C illustrates a detailed representational view of yet another system 360 for detecting voice-based commands originating from a user, in accordance with one embodiment. Specifically, FIG. 3C illustrates a variation of the embodiment of FIG. 3A having an exemplary configuration for processing ambient audio samples. Accordingly, various components of FIG. 3C have common numbering with those of FIG. 3A. The present system 360 may also be implemented in conjunction with features from any other embodiment listed herein, such as those described with reference to the other FIGS., such as FIG. 1A - 2.

Looking to FIG. 3C, the system 360 includes the processor 306 and memory module 308 electrically coupled to a comparator 304, e.g., as seen above in FIG. 3A. However, the processor 306 and memory module 308 are also coupled to a second comparator 362. The comparators 304, 362 thereby both inspect audio samples that are received from the analog microphone 302.

Depending on the implementation, the comparators 304, 362 may each be able to identify different types of audio signals. For instance, the comparators 304, 362 may be configured to evaluate different types (or portions) of signals. For example, the first comparator 304 may be configured to identify and evaluate portions of an audio sample having positive amplitudes, while the second comparator 362 is configured to identify and evaluate portions of an audio sample having negative amplitudes. The comparators 304, 362 may thereby be implemented in series in some situations, e.g., such that the ambient audio samples are evaluated sequentially. In still other implementations, the comparators 304, 362 may both be configured to evaluate portions of an audio sample having positive and negative amplitudes.

In other implementations, a first comparator 304 may be able to identify frequencies that are in a certain range, while the second comparator 362 is able to identify frequencies in a different range. According to an example, the first comparator 304 may be able to distinguish between audio samples having higher frequencies than the second comparator 362. In other words, the first comparator 304 may be a band pass filter, while the second comparator 362 is a high-pass filter that is able to distinguish between the audio samples in finer detail. In another example, the first comparator 304 may be a band pass filter, while the second comparator 362 is a low-pass filter that is able to distinguish between the low frequency audio samples in finer detail. Each ambient audio sample identified by the analog microphone 302 may thereby be sent to both comparators 304, 362 in parallel or series.

Implementing two comparators 304, 362 thereby increases the accuracy by which audio samples may be evaluated. The added granularity afforded by the second sample range allows for the two comparators 304, 362 to identify additional states, which allows for the audio samples to be inspected in finer detail and characterized as being either of interest or not. This ultimately results in voice detection functionality being improved for the system 360. In turn, the processor 306 may be kept in a deep-sleep state with a greater degree of accuracy such that the system is able to more effectively identify audio signals which correspond to voice-based commands.

Various ones of the approaches included herein are thereby able to determine frequency information corresponding to received audio samples without actually performing frequency domain analysis. Again, this significantly reduces power consumption and compute resource allocation by actually reducing the number of audio samples that are evaluated by the processor. Thus, some of the approaches are desirably able to improve the efficiency by which audio samples of interest are identified and handled.

Looking further to FIG. 3D, another detailed representational view of a system 370 for detecting voice-based commands originating from a user, in accordance with another embodiment. Specifically, FIG. 3D illustrates a variation of the embodiment of FIG. 3A having an exemplary configuration for processing ambient audio samples. Accordingly, various components of FIG. 3D have common numbering with those of FIGS. 3A and 3C. The present system 370 may also be implemented in conjunction with features from any other embodiment listed herein, such as those described with reference to the other FIGS., such as FIG. 1A-2.

Looking to FIG. 3D, the system 370 includes the processor 306 and memory module 308 electrically coupled to both comparators 304, 362 e.g., as seen above in FIG. 3C. However, both of the comparators 304, 362 are further coupled to audio filters 374, 372 respectively. Audio samples collected by the analog microphone 302 may thereby be provided to both of the audio filters 374, 372 such that each of the comparators 304, 362 are provided with different types of audio samples. The comparators 304, 362 may thereby be configured differently than each other in some implementations. It should also be noted that the comparators 304, 362 and audio filters 374, 372 may be positioned in series in some approaches.

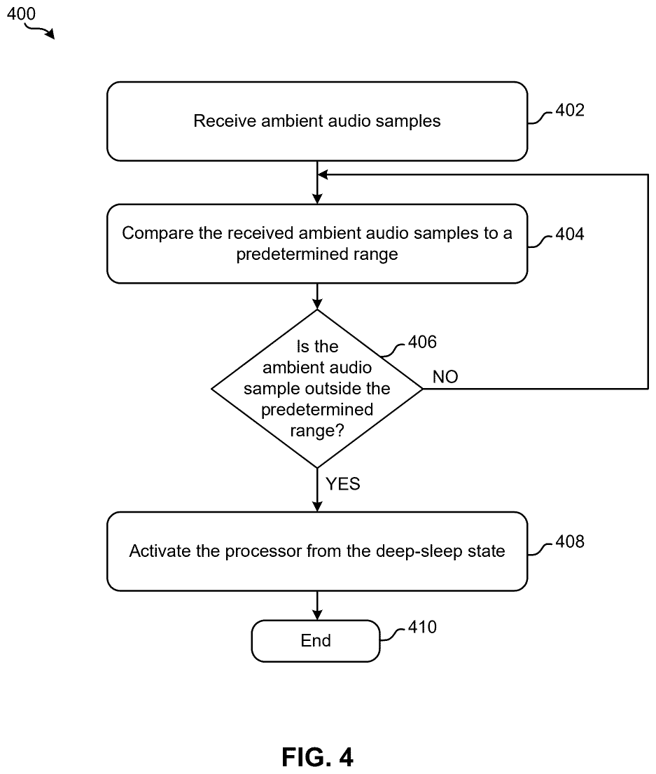

While the comparators included herein may be configured differently depending on the implementation, each is preferably able to evaluate audio sample information with respect to a standard. Accordingly, any of the comparators included herein may be configured in some implementations to perform one or more of the processes included in method 400 below. Looking specifically to FIG. 4, a flowchart of a method 400 for detecting voice-based commands originating from a user has been shown according to one embodiment. The method 400 may be performed in accordance with the present invention in any of the environments depicted in FIGS. 1A-3D, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. Thus, while the processes of method 400 are described as being partially or entirely performed by a comparator (e.g., see 304, 362 of FIGS. 3A-3D) receiving audio samples from an analog microphone, in various other embodiments, one or more processes of method 400 may be performed by a controller, a processor, a computer, etc., or some other device having one or more processors therein. Thus, in some embodiments, method 400 may be a computer-implemented method. Moreover, the terms computer, processor and controller may be used interchangeably with regards to any of the embodiments herein, such components being considered equivalents in the many various permutations of the present invention.

For those embodiments having a processor, the processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, operation 402 of method 400 includes receiving ambient audio samples collected by an analog microphone. In some implementations, the ambient audio samples may be received directly from the analog microphone used to detect and collect the samples. In other implementations, the audio samples collected by the analog microphone may first be passed through one or more filters (e.g., signal filters), before being received. For example, low-pass and/or high-pass filters may remove certain unwanted samples before a remainder of the samples reach the comparator.

Proceeding to operation 404, the received ambient audio samples are compared to a predetermined range. In other words, operation 404 includes comparing the audio samples to some standard to determine if they are of interest. According to some approaches, the comparator compares the ambient audio samples to a first predetermined range in order to filter out certain sounds. For instance, one implementation includes comparing a frequency of each of the ambient audio samples to a first predetermined frequency range to determine if any of the ambient audio samples are outside the first predetermined frequency range.

Background audio noise typically corresponds to combinations of higher and lower frequencies, while human voices (speech) primarily correspond to lower frequencies with a reduced number of transitions between higher and lower frequencies. An ambient audio sample may thereby be identified as being of interest if it is a lower frequency than frequencies in a predetermined range. The range may be predetermined by the user, based on industry standards, using testing performance metrics, etc. In some implementations, the frequency range may be adjusted dynamically over time as the system is tuned for the specific environment it is positioned in. It should also be noted that the term “lower than a range” is in no way intended to limit the invention. Rather than determining whether a value below a range, equivalent determinations may be made, e.g., as to whether an absolute value is above a threshold, whether a value is below a threshold, etc., depending on the desired approach.

Decision 406 further includes determining if each of the received ambient audio samples are outside the predetermined range. In other words, decision 406 includes determining whether each of the ambient audio samples are of interest for further evaluation. In response to determining that a given one of the ambient audio samples is not outside the predetermined range (e.g., not “of interest”), the processor is kept in a deep-sleep state. Accordingly, method 400 is shown as returning to operation 404. Additional ambient audio samples may thereby be evaluated before returning to decision 406. It follows that processes 404, 406 may be performed for each of the ambient audio samples individually in some approaches. In other approaches, more than one audio sample may be evaluated and/or compared to a predetermined range together. In some instances, method 400 may return directly to operation 402 from decision 406 to receive additional ambient audio samples that have been collected.

Method 400 advances from decision 406 to operation 408 in response to determining that one or more of the received ambient audio samples are outside the predetermined range. In other words, method 400 advances to operation 408 in response to determining that one or more of the received ambient audio samples are of interest. There, operation 408 includes activating the processor from the deep-sleep state.

As noted above, by maintaining a processor in a deep-sleep state while not actively being used, efficiency of the system is significantly improved. For example, the processor consumes far less electrical power while in the deep-sleep state, thereby resulting in longer battery life for implementations that rely on a battery power supply. Similarly, by implementing one or more comparators and/or signal filters, the processor performs fewer computational evaluations and processing overhead is significantly reduced as a result. It should also be noted that the system maintains operational effectiveness (e.g., accuracy) despite achieving these significant improvements in efficiency.

A processor may be activated from a deep-sleep state in a number of different ways depending on the implementation. For instance, in some implementations a comparator may activate a processor by sending a logic value to the processor along an interrupt line. In other implementations, the comparator may cause a voltage supplied to the processor to be increased such that the processor is able to perform additional functions, thereby effectively activating the processor from a deep-sleep state.

It follows that any one or more of the processes described herein may be implemented by the processor (e.g., from the processor's perspective). For instance, the processor may be preprogrammed to remain in a deep-sleep state unless a predetermined condition has been met. Depending on the implementation, the predetermined condition may correspond to a logic value being received along an interrupt line, a signal being received, a higher supply voltage being received, etc. The processor may also be configured (e.g., preprogrammed) to automatically return to the deep-sleep state in response to a predetermined number of audio samples being processed, a predetermined amount of time passing, one or more instructions being received, a buffer being emptied, etc. The processor thereby remains in the active state for a minimal amount of time.

Once in the active state, the processor is preferably able to determine if any of the ambient audio samples identified as being of interest actually correspond to a voice-based command originating from a user. In other words, the processor ensures that the identified audio samples are further evaluated, e.g., to determine additional details. According to some implementations, the processor may be used to perform any desired processes, such as audio signal evaluation (e.g., frequency domain analysis). The audio samples of interest may be further evaluated by implementing a VAD computer program product. The VAD computer program product includes program instructions which, when executed by the processor, cause the processor to evaluate the one or more ambient audio samples identified as being of interest. The processor is also able to verify whether each of the audio samples of interest correspond to a voice-based command originating from a user. The specific sub-processes that are performed to determine whether the audio samples of interest correspond to a voice-based command may include distributional semantics, semantics-based deep-learning (e.g., supervised, semi-supervised, or unsupervised machine learning), voice recognition technology, etc.

In other implementations, the audio samples of interest may be further evaluated by the processor sending one or more instructions to a VAD module (not shown). The VAD module may implement VAD computer program products and/or other software that has been hardened in a hardware block, e.g., as would be appreciated by one skilled in the art after reading the present description.

With continued reference to FIG. 4, method 400 advances from operation 408 to operation 410, whereby method 400 may end. However, it should be noted that although method 400 may end upon reaching operation 410, any one or more of the processes included in method 400 may be repeated in order to process additional ambient audio samples. In other words, any one or more of the processes included in method 400 may be repeated for ambient audio samples subsequently received from an analog microphone.

It follows that various ones of the implementations included herein are able to selectively transition processing components between a deep-sleep (e.g., reduced power and/or functionality) state and an active state. This allows for overarching systems to conserve a significant amount of power, compute overhead, system throughput, etc. Moreover, by increasing the amount of time the processing components are in a deep-sleep state, these improvements are amplified. Thus, by only processing audio samples that are identified as being of interest, embodiments described herein are able to achieve significant advancements over what has been conventionally achievable.

For instance, while an analog microphone may identify various audio signals, certain types of audio signals may provide more value than others. As previously mentioned, it is desirable to distinguish between different types of audio signals and identify ones that are of interest. This allows for compute resources to be conserved and dedicated to processing audio signals that are of interest, rather than all audio signals detected by the analog microphone, e.g., as described in further detail above.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A system for detecting voice-based commands originating from a user, the system comprising:
a processor;
a memory module communicatively coupled to the processor;
an analog microphone; and
a comparator communicatively coupled to the analog microphone, the comparator being configured to:
receive ambient audio samples collected by the analog microphone;
determine if any of the ambient audio samples are outside a first predetermined range;
in response to determining that one or more of the ambient audio samples are outside the first predetermined range, cause the processor to enter an active state from a deep-sleep state; and
in response to determining that none of the ambient audio samples are outside the first predetermined range, maintain the processor in the deep-sleep state.

2. The system of claim 1, wherein the processor is configured, when in the active state, to:
determine an amount of time since a last ambient audio sample was outside the first predetermined range;
determine whether the amount of time is outside a second predetermined range;
in response to determining that the amount of time is outside the second predetermined range:
cause the comparator to process updated ambient audio samples received from the analog microphone, and
store the processed ambient audio samples in a buffer; and
return to the deep-sleep state.

3. The system of claim 2, wherein the processor is further configured to:
return to the active state in response to a predetermined number of processed ambient audio samples being stored in the buffer;
evaluate the ambient audio samples in the buffer; and
use results of the evaluation to recalibrate the first predetermined range.

4. The system of claim 1, wherein the processor is configured, when in the active state, to:
determine if any of the one or more ambient audio samples determined as being outside the first predetermined range correspond to a voice-based command originating from the user.

5. The system of claim 4, wherein determining if any of the one or more ambient audio samples determined as being outside the first predetermined range correspond to a voice-based command originating from the user includes:
implementing a voice activity detection (VAD) computer program product comprising program instructions which, when executed by the processor, cause the processor to:
evaluate, by the processor, the one or more ambient audio samples determined as being outside the first predetermined range; and
verify, by the processor, whether each of the one or more ambient audio samples determined as being outside the first predetermined range correspond to a voice-based command originating from the user.

6. The system of claim 4, wherein determining if any of the one or more ambient audio samples determined as being outside the first predetermined range correspond to a voice-based command originating from the user includes:
instructing a voice activity detection (VAD) module to:
evaluate the one or more ambient audio samples determined as being outside the first predetermined range; and
verify whether each of the one or more ambient audio samples determined as being outside the first predetermined range correspond to a voice-based command originating from the user.

7. The system of claim 1, wherein determining if any of the ambient audio samples are outside the first predetermined range includes:
comparing a frequency of each of the ambient audio samples to the first predetermined range, the first predetermined range being a first predetermined frequency range.

8. The system of claim 7, wherein an ambient audio sample determined as being outside a first predetermined range has a lower frequency than frequencies in the first predetermined range.

9. The system of claim 1, wherein the system further includes:
a frequency-based filter electrically connected to the comparator, an output of the frequency-based filter being provided to the comparator.

10. The system of claim 9, wherein the frequency-based filter is a band-pass filter.

11. The system of claim 9, wherein the frequency-based filter is a low-pass filter.

12. The system of claim 1, wherein the processor is a microcontroller or a microprocessor.

13. The system of claim 1, wherein causing the processor to enter the active state includes:
sending a logic value to the processor along an interrupt line, wherein upon receiving the logic value, the processor enters the active state from the deep-sleep state.

14. A system for detecting voice-based commands originating from a user, the system comprising:
a processor;
an analog microphone;
first and second comparators, each of the first and second comparators being communicatively coupled to the analog microphone and the processor, wherein each of the first and second comparators are configured to:
receive ambient audio samples collected by the analog microphone;
determine if any of the ambient audio samples are outside predetermined ranges;
in response to determining that one or more of the ambient audio samples are outside one or more of the predetermined ranges, cause the processor to enter an active state from a deep-sleep state; and
in response to determining that none of the ambient audio samples are outside the predetermined ranges, maintain the processor in the deep-sleep state.

15. The system of claim 14, wherein the first comparator is configured to determine if any of the ambient audio samples are outside a first predetermined frequency range by comparing a frequency of each of the ambient audio samples to the first predetermined frequency range, wherein the second comparator is configured to determine if any of the ambient audio samples are outside a second predetermined frequency range by comparing the frequency of each of the ambient audio samples to the second predetermined frequency range, wherein the first predetermined frequency range is different than the second predetermined frequency range.

16. The system of claim 15, wherein the first comparator is configured to evaluate positive amplitudes of the ambient audio samples, wherein the second comparator is configured to evaluate negative amplitudes of the ambient audio samples.

17. The system of claim 15, wherein the first and second comparators are both configured to evaluate positive and negative amplitudes of the ambient audio samples.

18. The system of claim 14, wherein the system further includes:
a first frequency-based filter communicatively coupled to the first comparator, an output of the first frequency-based filter being provided to the first comparator; and
a second frequency-based filter communicatively coupled to the second comparator, an output of the second frequency-based filter being provided to the second comparator.

19. The system of claim 14, wherein the processor is configured, when in the active state, to:
implement a voice activity detection (VAD) computer program product, the VAD computer program product comprising program instructions which, when executed by the processor, cause the processor to:
evaluate, by the processor, the one or more ambient audio samples determined as being outside the first predetermined range; and
verify, by the processor, whether each of the one or more ambient audio samples determined as being outside the first predetermined range correspond to a voice-based command originating from the user.

20. A method for detecting voice-based commands originating from a user, the method comprising:
receiving, at an adjustable voltage-based comparator, ambient audio samples collected by an analog microphone communicatively coupled to the adjustable voltage-based comparator;
comparing the ambient audio samples to a predetermined range;
determining if any of the ambient audio samples are outside the predetermined range;
in response to determining that one or more of the ambient audio samples are outside the predetermined range, sending a logic value to the processor along an interrupt line, wherein upon receiving the logic value, the processor enters an active state from a deep-sleep state and begins evaluating the ambient audio samples determined as being outside the predetermined range; and
in response to determining that none of the ambient audio samples are outside the predetermined range, maintaining the processor in the deep-sleep state.
